(19) United States
(12) Patent Application Publication
(10) Pub. No.: US 2025/0094898 A1
(43) Pub. Date: Mar. 20, 2025

(54) SYSTEM AND METHOD FOR ITEM-SELLER RECOMMENDATION FOR ASSORTMENT GROWTH

(71) Applicant: Walmart Apollo, LLC, Bentonville, AR (US)

(72) Inventor: Kumar Saurav, Bangalore (IN)

(21) Appl. No.: 18/467,990

(22) Filed: Sep. 15, 2023

(51) Int. Cl. G06Q 10/0631; G06Q 10/0637; G06Q 30/0202

(52) U.S. Cl. CPC G06Q 10/06315; G06Q 10/06375; G06Q 30/0202

(57) ABSTRACT

Systems and methods for item-seller recommendation for assortment growth are disclosed. In some embodiments, a disclosed method includes: obtaining a plurality of machine learning models; receiving, from a computing device, a request for assortment growth in a marketplace; determining, based on the request, a corresponding arrangement of the plurality of machine learning models; generating, based on the plurality of machine learning models according to the corresponding arrangement, a recommendation list of item-seller combinations; and transmitting the recommendation list to the computing device.

### TECHNICAL FIELD

This application relates generally to assortment growth and, more particularly, to systems and methods for generating a recommendation list of item-seller combinations for assortment growth.

### BACKGROUND

To keep a marketplace competitive and a one-stop shop for customers, it is essential to have an exhaustive list of assortments as well as sellers offering those assortments. While assortments are important for sellers and the marketplace, a recommendation system is desired to grow a product assortment.

In various scenarios, a recommendation system may face different challenges to grow the product assortment. In one example, recommendation is requested to grow catalog for an existing seller to increase the offer density. In another example, recommendation is requested to onboard new items for customers to increase depth and breadth of the assortment. In yet another example, recommendation is requested to help a cold start seller to expand its catalog. There is no existing solution to address all of the above mentioned problems.

### SUMMARY

The embodiments described herein are directed to systems and methods for generating a recommendation list of item-seller combinations for assortment growth.

In various embodiments, a system including a non-transitory memory configured to store instructions thereon and at least one processor is disclosed. The at least one processor is configured to read the instructions to: obtain a plurality of machine learning models; receive, from a computing device, a request for assortment growth in a marketplace; determine, based on the request, a corresponding arrangement of the plurality of machine learning models; generate, based on the plurality of machine learning models according to the corresponding arrangement, a recommendation list of item-seller combinations; and transmit the recommendation list to the computing device.

In various embodiments, a computer-implemented method is disclosed. The computer-implemented method includes: obtaining a plurality of machine learning models; receiving, from a computing device, a request for assortment growth in a marketplace; determining, based on the request, a corresponding arrangement of the plurality of machine learning models; generating, based on the plurality of machine learning models according to the corresponding arrangement, a recommendation list of item-seller combinations; and transmitting the recommendation list to the computing device.

In various embodiments, a non-transitory computer readable medium having instructions stored thereon is disclosed. The instructions, when executed by at least one processor, cause at least one device to perform operations including: obtaining a plurality of machine learning models; receiving, from a computing device, a request for assortment growth in a marketplace; determining, based on the request, a corresponding arrangement of the plurality of machine learning models; generating, based on the plurality of machine learning models according to the corresponding arrangement, a recommendation list of item-seller combinations; and transmitting the recommendation list to the computing device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to recommend item-seller combinations for assortment growth, in accordance with some embodiments of the present teaching.

FIG. 2 is a block diagram of a recommendation computing device, in accordance with some embodiments of the present teaching.

FIG. 3 is a block diagram illustrating various portions of a system for recommending item-seller combinations, in accordance with some embodiments of the present teaching.

FIG. 4 is a block diagram illustrating various portions of a recommendation computing device, in accordance with some embodiments of the present teaching.

FIG. 5 illustrates various arrangements of machine learning models obtained from a retrieval model, in accordance with some embodiments of the present teaching.

FIG. 6 illustrates an exemplary process for generating or training a retrieval model, in accordance with some embodiments of the present teaching.

FIG. 7 illustrates an exemplary process for generating recommendations based on a retrieval model, in accordance with some embodiments of the present teaching.

FIG. 8 illustrates an exemplary structure of a query model, in accordance with some embodiments of the present teaching.

FIG. 9 illustrates an exemplary structure of a candidate model, in accordance with some embodiments of the present teaching.

FIG. 10 illustrates an exemplary structure of a deep retrieval model, in accordance with some embodiments of the present teaching.

FIG. 11 illustrates an exemplary process for training a ranking model, in accordance with some embodiments of the present teaching.

FIG. 12 is a flowchart illustrating an exemplary method for recommending item-seller combinations, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

A marketplace, including an e-commerce marketplace, may face different types of challenges to grow the product assortment so that the customers have more options to choose from. A first challenge is to determine the best sellers that can bring a cold start item or new item to the marketplace, given a high demand product selection for the new item. A second challenge is to recommend more items to an existing seller, to increase the catalog size and/or to win the buy-box and expand sales for the seller. A third challenge is to recommend the best items to expand the catalog of a cold start seller or new seller.

With more than thousands of sellers and more than millions of transactable items, and with new sellers and items being added every day for a big marketplace, it is important to have a scalable solution which could take care of all of the above-mentioned assortment recommendation needs using a single accurate model. The present teaching solves the above problems with a multi-purpose recommendation system, which combines seller context, product context and a ranking model to prioritize each seller-product combination or item-seller combination. In some embodiments, the multi-purpose recommendation system includes a machine learning based two-tower retrieval model, which uses covariates for sellers and items respectively for each tower model. A ranking model may sit on top of the two-tower retrieval model to give ranked recommendations. The multi-purpose recommendation system significantly increases the recommendation acceptance rate from the sellers.

In some embodiments, the disclosed recommendation system utilizes a single efficient model (e.g. the two-tower retrieval model) to generate recommendations to solve all of the above mentioned problems. The two-tower retrieval model comprises a seller model and an item model, which are arranged in different manners for solving different problems. The single two-tower retrieval model would require less maintainability compared to individual models for each different problem.

An offer density problem is to recommend items to help an existing seller growing its catalog. A solution to this problem will help the existing seller to onboard items not carried by the seller before, thus increasing the offer density for the items and/or the seller. To solve the offer density problem, the seller model is arranged first and the item model is arranged after the seller model, to generate a recommended list of items for the existing seller.

A cold start item problem is to recommend sellers most probable to bring assortment of the cold start item based on how similar assortments are being carried by the sellers. The cold start item problem is important as a marketplace wants to have an exhaustive list of assortments and sellers offering those assortments. It is imperative to onboard the gap items which are not present in the assortments or have very little offers. There are multiple ways to get the set of gap assortments, including: (1) leveraging keywords corresponding to an internal search to identify the list of gap or low offer items or assortments; (2) leveraging keywords used in the external search fetching no results to identify the gap items which are present in other marketplaces but not in the concerned marketplace. A solution to this problem will help the recommended sellers to onboard new items not present in the marketplace earlier. To solve the cold start item problem, the item model is arranged first and the seller model is arranged after the item model, to generate a recommended list of sellers for the cold start item or new item.

A cold start seller problem is to recommend items to a cold start seller or new seller with no or few history of transaction within the marketplace. To solve the cold start seller problem, the item model is arranged first and another copy of the item model is arranged afterwards, to generate a recommended list of items for the cold start seller or new seller.

In some embodiments, the seller model is configured to compute embeddings for sellers based on seller features including: e.g. seller ID, a brand in which a seller is selling, the number of days the seller has been registered with the marketplace, etc. In some embodiments, the item model is configured to compute embeddings vectorized tokens for items based on item features including: e.g. item title, item description, etc. The embeddings generated from both tower models (the seller model and the item model) may be joined, e.g. via a lightweight scoring function, to compute an affinity score for an item-seller pair or combination. The affinity score indicates a degree of affinity between the item and the seller in the combination, and can be used to determine whether the combination should be retrieved for recommendation. For example, while there are millions of candidate item-seller pairs, only item-seller pairs having affinity scores higher than a predetermined threshold can be retrieved for recommendation. In addition, the ranking model may give a ranking for each retrieved seller-item pair based on the seller embeddings and item embeddings, to further filter out recommended item-seller combinations.

Furthermore, in the following, various embodiments are described with respect to methods and systems for generating a recommendation list of item-seller combinations for assortment growth are disclosed. In some embodiments, a disclosed method includes: obtaining a plurality of machine learning models; receiving, from a computing device, a request for assortment growth in a marketplace; determining, based on the request, a corresponding arrangement of the plurality of machine learning models; generating, based on the plurality of machine learning models according to the corresponding arrangement, a recommendation list of item-seller combinations; and transmitting the recommendation list to the computing device.

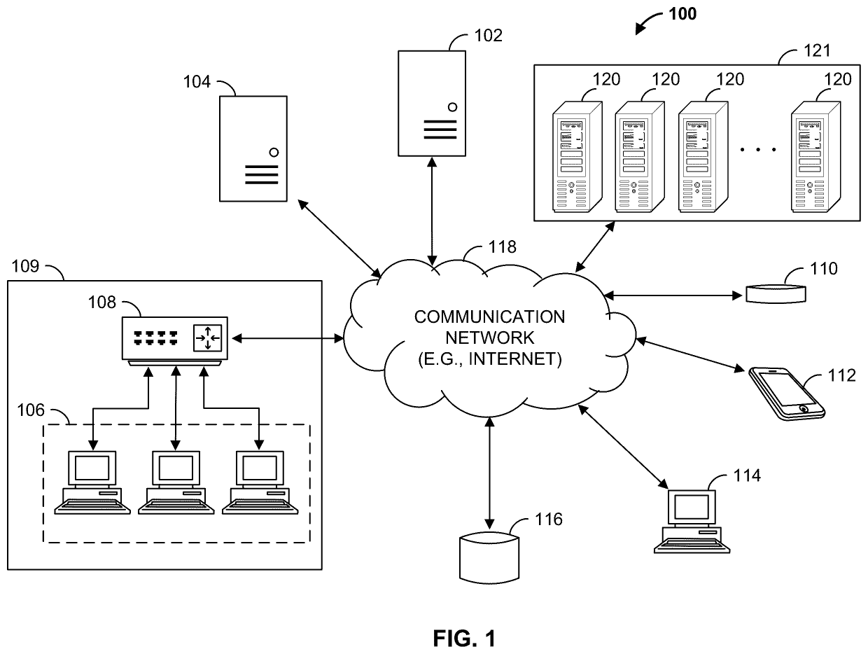

Turning to the drawings, FIG. 1 is a network environment 100 configured to recommend item-seller combinations for assortment growth, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a recommendation computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The recommendation computing device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the recommendation computing device 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the recommendation computing device 102, the processing devices 120, and/or the web server 104 are operated by a retailer. The multiple user computing devices 110, 112, 114 may be operated by customers or sellers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the recommendation computing device 102 over the communication network 118. The workstation(s) 106 may send data to, and receive data from, the recommendation computing device 102. For example, the workstation(s) 106 may transmit data identifying items purchased by a customer at the store 109 to the recommendation computing device 102.

Although FIG. 1 illustrates three user computing devices 110, 112, 114, the network environment 100 can include any number of user computing devices 110, 112, 114. Similarly, the network environment 100 can include any number of the recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view item advertisements for items displayed on the website, and may click on item advertisements, for example. The website may capture these activities as user session data, and/or transmit the user session data to the recommendation computing device 102 over the communication network 118. The website may also allow the customer to add one or more of the items to an online shopping cart, and allow the customer to perform a “checkout” of the shopping cart to purchase the items. In some examples, the web server 104 transmits purchase data identifying items the customer has purchased from the website to the recommendation computing device 102.

In some examples, a seller may operate one of the user computing devices 110, 112, 114 to initiate a web browser or a user interface (e.g. a seller center or seller portal) that is associated with a website hosted by the web server 104. The seller may, via the web browser or the user interface, view and manage existing items sold by the seller, view items recommended by the retailer based on recommendations generated by the recommendation computing device 102, and/or create a new listing for a recommended item to expand its catalog. The website may capture at least some of these activities as recommendation data. The web server 104 may transmit the recommendation data to the recommendation computing device 102 over the communication network 118, and/or store the recommendation data to the database 116.

In some embodiments, the web server 104 may transmit a recommendation request to the recommendation computing device 102, e.g. upon a request from an existing seller, a highly demanded new item, a registration of a new seller, or a pre-configured periodic recommendation job. The recommendation request may be sent standalone or together with recommendation related data of the website. In some examples, the recommendation request may indicate a request type being one of the following: requesting item recommendation for an existing seller, requesting seller recommendation for a new item, or requesting item recommendation for a new seller. In some examples, the recommendation request may also carry or indicate historical recommendation data of previous recommendations on the website.

In some examples, the recommendation computing device 102 may execute one or more models (e.g., algorithms), such as a machine learning model, deep learning model, statistical model, etc., to determine recommended item-seller combinations. The recommendation computing device 102 may first obtain a plurality of machine learning models and determine the request type of the recommendation request. Then, the recommendation computing device 102 determines, based on the request type, a corresponding arrangement of the plurality of machine learning models. The recommendation computing device 102 generates, based on the plurality of machine learning models according to the corresponding arrangement, a recommendation list of item-seller combinations. In some embodiments, each item-seller combination corresponds to an item and a corresponding seller such that an affinity score computed for the item and the seller is larger than a threshold. The recommendation computing device 102 may then transmit the recommendation list to the web server 104 for displaying the recommendation list to corresponding seller(s).

The recommendation computing device 102 is further operable to communicate with the database 116 over the communication network 118. For example, the recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the recommendation computing device 102, in some examples, the database 116 can be a local storage device, such as a hard drive, a non-volatile memory, or a USB stick. The recommendation computing device 102 may store online purchase data received from the web server 104 in the database 116. The recommendation computing device 102 may receive in-store purchase data from different stores 109 and store them in the database 116. The recommendation computing device 102 may also receive from the web server 104 user session data identifying events associated with browsing sessions, and may store the user session data in the database 116. The recommendation computing device 102 may also determine item-seller recommendations in response to a recommendation request received from the web server 104, and may store data related to the item-seller recommendations in the database 116.

In some examples, the recommendation computing device 102 generates training data for a plurality of models (e.g., machine learning models, deep learning models, statistical models, algorithms, etc.). The recommendation computing device 102 trains the models based on a same set of training data, and stores the models in a database, such as in the database 116 (e.g., a cloud storage). In some embodiments, the recommendation computing device 102 may perform model training upon a request from the web server 104. In some embodiments, the recommendation computing device 102 may perform model training automatically without any request from the web server 104.

The models, when executed by the recommendation computing device 102, allow the recommendation computing device 102 to determine recommended item-seller combinations for assortment growth. In some examples, the recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the recommendation computing device 102 may generate item-seller recommendations.

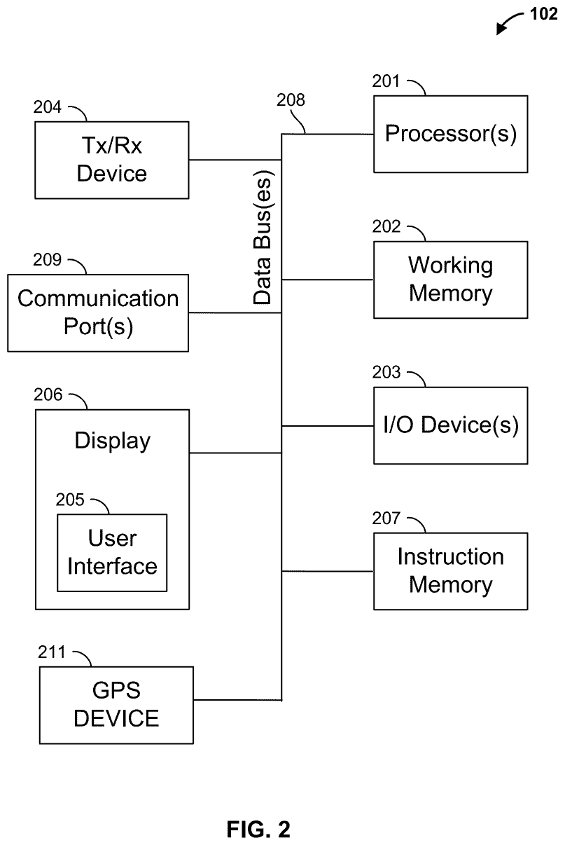

FIG. 2 illustrates a block diagram of a recommendation computing device, e.g. the recommendation computing device 102 of FIG. 1, in accordance with some embodiments of the present teaching. In some embodiments, each of the recommendation computing device 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the recommendation computing device 102 can be combined, omitted, and/or replicated. In addition, it will be appreciated that additional elements other than those illustrated in FIG. 2 can be added to the recommendation computing device 102.

As shown in FIG. 2, the recommendation computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the recommendation computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the recommendation computing device 102 can include a single memory unit configured to operate as both instruction memory and working memory. Further, although embodiments are discussed herein including non-volatile memory, it will be appreciated that the recommendation computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the recommendation computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the recommendation computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the recommendation computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the recommendation computing device 102 and/or the web server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the recommendation computing device 102 may determine a local geographical area (e.g., town, city, state, etc.) of its position.

In some embodiments, the recommendation computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

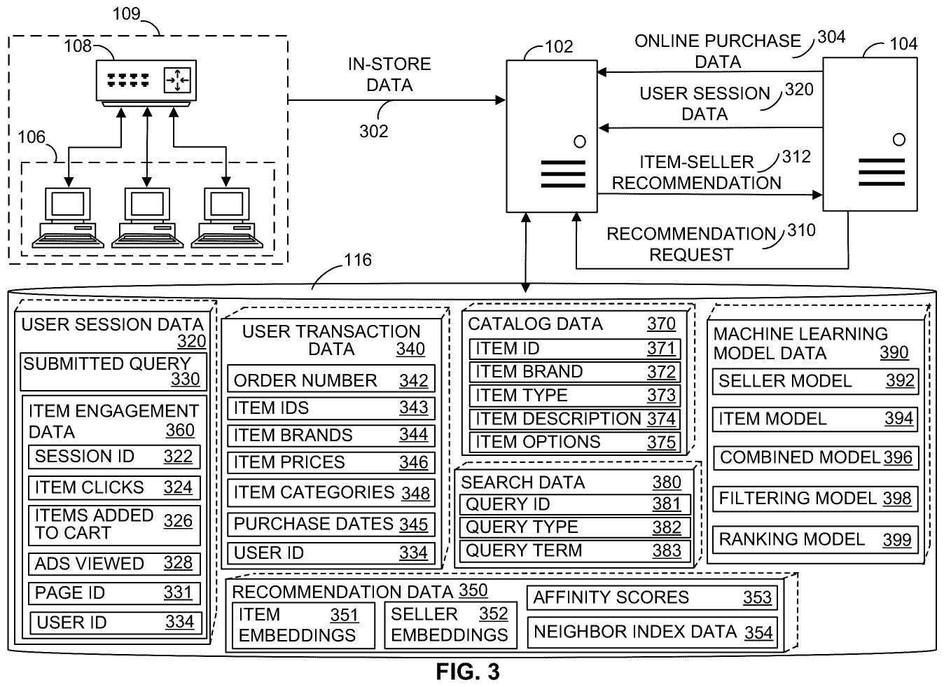

FIG. 3 is a block diagram illustrating various portions of a system for recommending item-seller combinations, e.g. the system shown in the network environment 100 of FIG. 1, in accordance with some embodiments of the present teaching. As indicated in FIG. 3, the recommendation computing device 102 may receive user session data 320 and online purchase data 304 from the web server 104. The user session data 320 identifies, for each user (e.g., customer), data related to that user's browsing session, such as when browsing a retailer's webpage hosted by the web server 104. The recommendation computing device 102 may store the user session data 320 into the database 116.

In some examples, the user session data 320 may include item engagement data 360 and/or submitted query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed and/or clicked during the browsing session, page ID 331 identifying a webpage (product page, search result page, home page, etc.) the user engaged with, and user ID 334 (e.g., a customer ID, retailer website login ID, a cookie ID, etc.). The submitted query data 330 may identify one or more searches conducted by a user during a browsing session (e.g., a current browsing session).

The online purchase data 304 may identify and characterize one or more online purchases, such as purchases made by the user and other users via a retailer's website hosted by the web server 104. The recommendation computing device 102 may also receive in-store data 302 from the store 109, which identifies and characterizes one or more in-store purchases, in-store advertisements, in-store shopping data, etc. In some embodiments, the in-store data 302 may also indicate availability of items in the store 109, and/or user IDs that have selected the store 109 as a default store for picking up online orders.

The recommendation computing device 102 may parse the in-store data 302 and the online purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item categories 348 identifying a category of each item purchased, a purchase date 345 identifying the purchase date of the purchase order, and user ID 334 for the user making the corresponding purchase.

The database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., a product type like grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store search data 380, which may identify one or more attributes of a plurality of queries submitted by users on the website hosted by the web server 104 and/or on a website of a search engine associated with the web server 104. The search data 380 may include, for each of the plurality of queries, a query ID 381 identifying a query previously submitted by users, a query type 382 (e.g., a head query, a torso query, or a tail query), and query term 383 identifying terms in a query.

In some embodiments, the database 116 may further store recommendation data 350, which may identify data related to item-seller recommendation for the retailer's website hosted by the web server 104. The recommendation data 350 may identify item embeddings 351 identifying embeddings for items being sold on the website, seller embeddings 352 identifying embeddings for sellers associated with the website, affinity scores 353 identifying scores each representing a degree of affinity between an item and a seller in a corresponding item-seller combination, and neighbor index data 354 identifying neighboring embeddings for each seller embedding and each item embedding.

The database 116 may also store machine learning model data 390 identifying and characterizing one or more machine learning models and related data for recommending item-seller combinations. For example, the machine learning model data 390 may include a seller model 392, an item model 394, a combined model 396, a filtering model 398, and a ranking model 399.

In some embodiments, the seller model 392 may be used to compute a seller embedding for a seller based on features of the seller. The features of the seller may include at least one of: an ID of the seller, brands carried by the seller, a time period the seller has been registered with the website, a time period the seller has been actively selling items on the website, or types of items being sold by the seller. In some embodiments, the seller model 392 may be built based on a neural network, where each seller embedding generated by the neural network may be a high-dimensional vector.

In some embodiments, the item model 394 may be used to compute an item embedding for an item based on features of the item. The features of the item may include at least one of: a title of the item, a description of the item, or an item type of the item. In some embodiments, the item model 394 may be built based on a neural network, where each item embedding generated by the neural network may be a high-dimensional vector.

In some embodiments, the combined model 396 may be used to combine the seller embeddings generated by the seller model 392 and the item embeddings generated by the item model 394, to form item-seller combinations each with an associated affinity score. In some examples, for each item-seller pair or combination, the combined model 396 may perform a dot product operation based on the embeddings of the item and the seller in the pair or combination, to compute an affinity score representing a degree of affinity between the item and the seller. A higher affinity score represents a higher degree of affinity between the item and the seller. An affinity indicates how close the embedding of the seller is to the embeddings of the items present in the marketplace, by considering the catalog of the seller.

In some embodiments, the seller model 392, the item model 394 and the combined model 396 are included in a same retrieval model and are trained together to find optimal hyperparameters and weights in layers of neural networks to optimize an objective function based on training data. The training data may be generated based on historical data of the sellers, including inventory data and/or catalog data for the sellers. The training data may include labelled affinity scores for item-seller combinations. In some examples, for each seller in the training data, an item within a catalog of the seller, i.e. being sold by the seller, is labelled to have an affinity score of 1 with respect to the seller; while an item outside the catalog of the seller, i.e. not being sold by the seller, is labelled to have an affinity score of 0 with respect to the seller. In some examples, the objective function may represent a total difference between a computed affinity score and a labelled affinity score for all of the item-seller combinations. In this case, the training of the retrieval model can find the optimal hyperparameters and weights to minimize the objective function. Based on the affinity scores of the item-seller combinations, a list of candidate embeddings can be determined for each query embedding. For example, for each seller, a list of candidate item embeddings can be determined, where an affinity score between the seller's embedding and each of the candidate item embeddings is larger than a predetermined threshold.

In some embodiments, the filtering model 398 may be used to filter recommendation candidates for a given query element, e.g. filter candidate items for a given seller, or filter candidate sellers for a given item. In some examples, the filtering model 398 is used to filter out irrelevant cases like items which are already being carried by the seller or have been recommended earlier, from the list of recommendations.

In some embodiments, the ranking model 399 may be used to rank filtered candidates for a given query element, e.g. rank candidate items for a given seller, or rank candidate sellers for a given item. In some examples, the ranking model 399 is used to rank the filtered candidates to further refine the recommendations, e.g. based on seller and item title.

In some examples, the recommendation computing device 102 receives (e.g., in real-time) from the web server 104, a recommendation request 310 seeking some item-seller recommendations for assortment growth. In response, the recommendation computing device 102 generates item-seller recommendation 312 identifying recommended item-seller combinations, and transmits the item-seller recommendation 312 to the web server 104. In some examples, the item-seller recommendation 312 includes a list of items recommended to an existing seller. In some examples, the item-seller recommendation 312 includes a list of sellers recommended for a new item or cold start item. In some examples, the item-seller recommendation 312 includes a list of items recommended to a new seller or cold start seller. In each case, the item-seller recommendation 312 may be in the form of item-seller combinations, where the item-seller combinations may have a common seller or a common item.

In some embodiments, the web server 104 may generate a recommended list of items based on the item-seller recommendation 312, and transmit the recommended list of items to a seller (e.g. an existing seller or a new seller). In some embodiments, the web server 104 may determine a list of sellers based on the item-seller recommendation 312, and transmit a recommended item (e.g. a new item) to the list of sellers. Each recommended item may be presented to a corresponding seller together with other associated information, e.g. item description, item division, item type or category, item brand, buy-box price for the item if it is already in the retailer's catalog, external price for the item if it is sold outside the marketplace.

A buy-box price for a recommended item will be shown to a seller who receives the recommended item, if the recommended item is an existing item already being offered for sale in the marketplace, e.g. via a seller center or seller portal on the website of the retailer. That is, in response to a request for offer density increase, presence of a buy-box price when recommending a corresponding item to a seller indicates that: the item is already part of the retailer's catalog, but the seller is not carrying the item.

A buy-box price for a recommended new item or cold start item will not be shown to a seller who receives the recommendation, or a note like “no offers yet” will be shown to the seller, via the seller center or seller portal. That is, in response to a request for cold start item problem, the missing of a buy-box price when recommending a corresponding item to a seller indicates that: the item is not present in the retailer's catalog.

For a cold start seller problem, a buy-box price for a recommended item may or may not be shown to a seller who receives the recommendation via the seller center or seller portal, depending on whether the recommended item is a new item or existing item. That is, in response to a request for cold start seller problem, a list of recommended items will be presented to the seller. For each recommended item in the list, a corresponding buy-box price is shown if the recommended item is already part of the retailer's catalog, and no buy-box price is shown if the recommended item is not present in the retailer's catalog.

In some embodiments, the recommendation computing device 102 may assign one or more of the operations described above to a different processing unit or virtual machine hosted by the one or more processing devices 120. Further, the recommendation computing device 102 may obtain the outputs of the these assigned operations from the processing units, and generate the item-seller recommendation 312 based on the outputs.

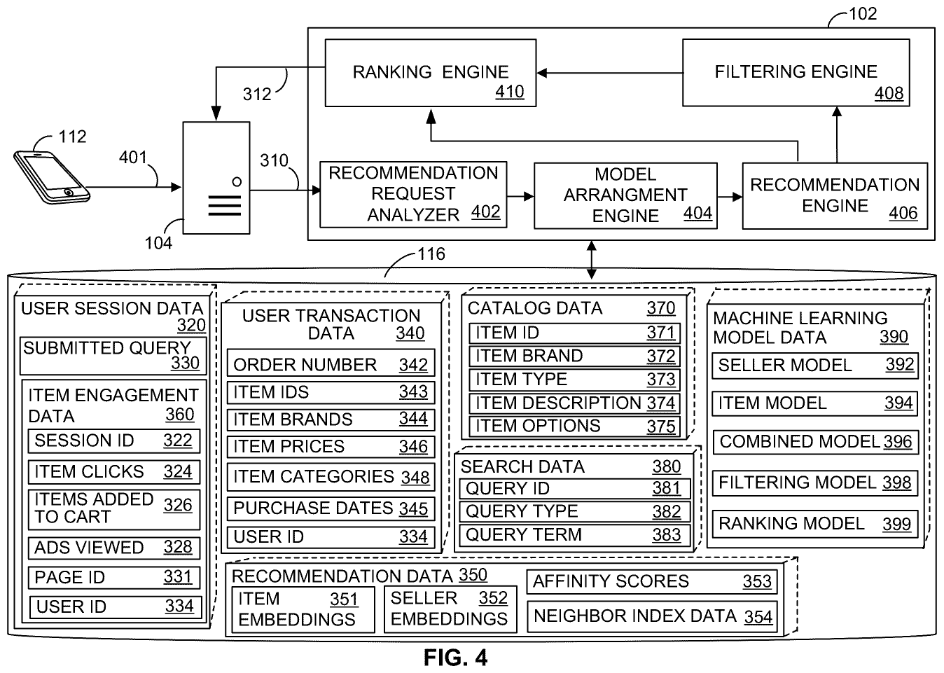

FIG. 4 is a block diagram illustrating various portions of a recommendation computing device, e.g. the recommendation computing device 102 in FIG. 1, in accordance with some embodiments of the present teaching. As shown in FIG. 4, the recommendation computing device 102 includes a recommendation request analyzer 402, a model arrangement engine 404, a recommendation engine 406, a filtering engine 408, and a ranking engine 410. In some examples, one or more of the recommendation request analyzer 402, the model arrangement engine 404, the recommendation engine 406, the filtering engine 408, and the ranking engine 410 are implemented in hardware. In some examples, one or more of the recommendation request analyzer 402, the model arrangement engine 404, the recommendation engine 406, the filtering engine 408, and the ranking engine 410 are implemented as an executable program maintained in a tangible, non-transitory memory, such as instruction memory 207 of FIG. 2, which may be executed by one or processors, such as the processor 201 of FIG. 2.

For example, the recommendation request analyzer 402 may obtain from the web server 104 a recommendation request 310 as a message 401 is sent from the user device 112 to the web server 104, e.g. as a seller logs in an account on a retailer's website via the user computing device 112, or as a seller clicks on the retailer's website via the user computing device 112 to request item recommendations. In some embodiments, the recommendation request analyzer 402 may obtain the recommendation request 310 periodically, based on a pre-configuration, e.g. every week, every two weeks, or every month. The recommendation request analyzer 402 may analyze the recommendation request 310 to determine a request type. In various examples, the request type may be: requesting item recommendation for an existing seller, requesting seller recommendation for a new or cold start item, or requesting item recommendation for a new or cold start seller.

In addition, the recommendation request analyzer 402 may obtain recommendation related data, item related data and/or seller related data associated with the recommendation request 310, e.g. by parsing the user transaction data 340, the catalog data 370, the search data 380, and/or the recommendation data 350 in the database 116. The recommendation request analyzer 402 may send the obtained data and the determined request type to the model arrangement engine 404 for model arrangement.

In some embodiments, the model arrangement engine 404 may obtain a plurality of machine learning models, e.g. the seller model 392 and the item model 394 from the database 116. The model arrangement engine 404 may determine a corresponding arrangement of the plurality of machine learning models, based on the request type determined by the recommendation request analyzer 402. In some examples, the item model 394 may be arranged after the seller model 392, when the request type is requesting item recommendation for an existing seller. In some examples, the seller model 392 may be arranged after the item model 394, when the request type is requesting seller recommendation for a new or cold start item. In some examples, the item model 394 may be arranged after another copy of the item model 394, when the request type is requesting item recommendation for a new or cold start seller. The model arrangement engine 404 may send the corresponding model arrangement information to the recommendation engine 406 for recommendation generation.

In some embodiments, the recommendation engine 406 may generate a list of item-seller combinations, based on the plurality of machine learning models according to the corresponding arrangement. Each of the item-seller combinations is formed by an item and a seller. The item-seller combinations may have a common seller, when the request type is requesting item recommendation for an existing seller or requesting item recommendation for a new or cold start seller. The item-seller combinations may have a common item, when the request type is requesting seller recommendation for a new or cold start item. In some embodiments, the recommendation engine 406 may retrieve data of the list of item-seller combinations from the database 116. In some embodiments, each item-seller combination in the list of item-seller combinations has an affinity score larger than a predetermined threshold. The affinity score may be computed based on a retrieval model, e.g. the combined model 396 in the database 116, between two embeddings, e.g. a seller embedding and an item embedding. The recommendation engine 406 may compute the seller embedding based on the seller model 392 in the database 116; and compute the item embedding based on the item model 394 in the database 116. The recommendation engine 406 may send the retrieved data of the list of item-seller combinations to the filtering engine 408 for filtering.

In some embodiments, the filtering engine 408 may filter the list of recommended item-seller combinations generated by the recommendation engine 406, e.g. based on the filtering model 398 in the database 116. In some embodiments, the filtering engine 408 can remove irrelevant candidates from the item-seller combinations, e.g. combinations including items already in a catalog of a query seller, and combinations including items already recommended to a query seller, when the request type is requesting recommended items for the query seller (a new seller or existing seller). After the filtering, the filtering engine 408 may generate and transmit a filtered list of item-seller combinations to the ranking engine 410 for ranking.

In some embodiments, the ranking engine 410 in this example may rank the filtered list of item-seller combinations generated by the filtering engine 408, to further refine the recommendation list. The ranking engine 410 may rank the filtered list of item-seller combinations based on the ranking model 399 in the database 116, to generate the item-seller recommendation 312. In some embodiments, the ranking at the ranking engine 410 is performed based on the seller embeddings and item embeddings computed by the recommendation engine 406. The ranking engine 410 transmits the item-seller recommendation 312 to the web server 104 as a response to the recommendation request 310.

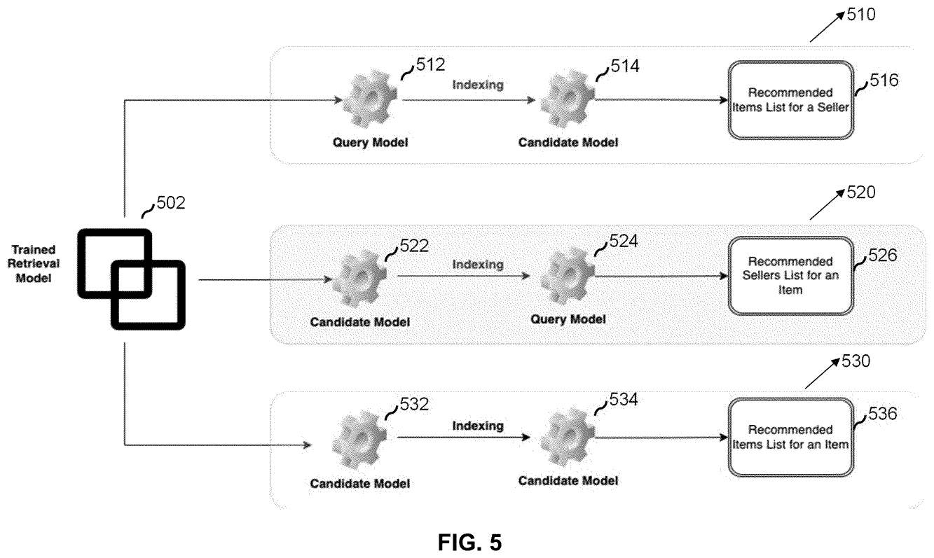

FIG. 5 illustrates various arrangements of machine learning models obtained from a retrieval model 502, in accordance with some embodiments of the present teaching. In some embodiments, the retrieval model 502 may be a pre-trained machine learning model, e.g. based on a neural network. In some embodiments, the retrieval model 502 may be a multi-tower model including a plurality of tower models, e.g. a query model and a candidate model. In this case, the query model refers to a seller model configured to compute a seller embedding for a seller based on features of the seller; and the candidate model refers to an item model configured to compute an item embedding for an item based on features of the item. The query model and the candidate model are trained together as the retrieval model 502 is trained.

During the inference stage after the training, it is important to retrieve the list of recommended items from the catalog of millions of items in the marketplace. A crude or brute force way is to get similarity of a seller (query) with all the candidates (items) present in the catalog, sort the candidates based on highest affinity scores to generate the list of recommended items. Given the humongous size of the candidates, a scalable nearest neighbor approach may be used to determine the nearest candidate embedding for a given query embedding using an optimized combination of: a tree based space partition, an asymmetric hashing, connotation, and inverted indexes. The query model and the candidate model are properly combined to create the index for approximate nearest neighbor (ANN), while the tower models structure are utilized with various seller and item features to create the embeddings to ultimately retrieve the item-seller combinations.

The retrieval model 502 may be a machine learning model leveraging seller and item related contextual information using embeddings to tackle three different problems with a single model solution. The three different problems are: (1) item-offer density problem seeking item recommendation for an existing seller; (2) cold start item problem seeking seller recommendation for a cold start item; and (3) cold start seller problem seeking item recommendation for a cold start seller. The two tower models, query model and candidate model, may be arranged in different manners to solve different problems.

As shown in FIG. 5, a first arrangement 510 may be used to solve the item-offer density problem. That is, by arranging a query model 512 followed by a candidate model 514, a list of recommended items 516 for an existing seller can be generated based on the query model 512 and the candidate model 514 according to the first arrangement 510.

A second arrangement 520 may be used to solve the cold start item problem. That is, by arranging a candidate model 522 followed by a query model 524, a list of recommended sellers 526 for the cold-start item can be generated based on the candidate model 522 and the query model 524 according to the second arrangement 520.

A third arrangement 530 may be used to solve the cold start seller problem. That is, by arranging a candidate model 532 followed by another candidate model 534, a list of recommended items 530 for the cold-start seller can be generated based on the candidate model 532 and the candidate model 534 according to the third arrangement 530.

In FIG. 5, all query models 512, 524 have the same structure and weights after training, while all candidate models 514, 522, 532, 534 have the same structure and weights after training. As such, a single retrieval model 502 including query model and candidate model may be used to solve different recommendation problems based on different tower model arrangements. The retrieval model 502 including query model and candidate model is agnostic to both geography and language. For example, the retrieval model 502 is applicable everywhere in any language.

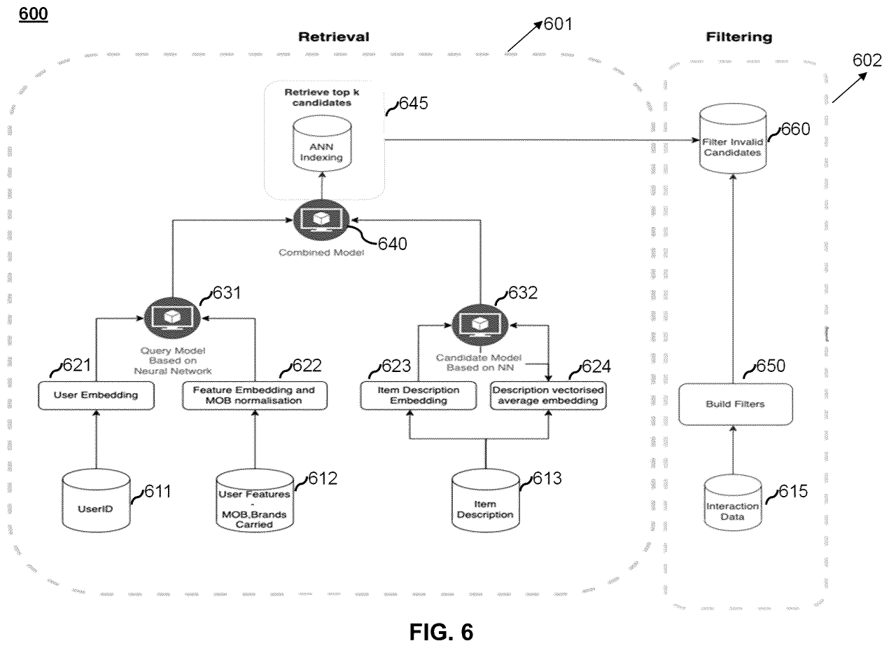

FIG. 6 illustrates an exemplary process 600 for generating or training a retrieval model 601, together with a filtering model 602, in accordance with some embodiments of the present teaching. In some embodiments, the process 600 can be carried out by one or more computing devices, such as the recommendation computing device 102 and/or the cloud-based engine 121 of FIG. 1.

As shown in FIG. 6, the retrieval model 601 includes a query model 631, a candidate model 632, and a combined model 640. In this example, the query model 631 refers to a seller model configured to compute a seller embedding for a seller based on features of the seller; and the candidate model 632 refers to an item model configured to compute an item embedding for an item based on features of the item.

In some embodiments, the query model 631 is built based on a neural network to convert seller features to a high-dimensional embedding. For example, for each seller, the seller features may include: a user or seller ID 611 of the seller, and other seller features 612 including a brand carried by the seller and the number of days the seller has been on book or registered with the marketplace. A user embedding 621 may be computed based on the seller ID 611; while other feature embeddings 622 may be computed based on the other seller features 612. The query model 631 can be configured to generate a combined seller embedding for the seller. The neural network for the query model 631 includes multiple layers and hyperparameters and weights to be optimized for generating each of the embeddings 621, 622 and the combined seller embedding by the query model 631.

In some embodiments, the candidate model 632 is also built based on a neural network to convert item features to a high-dimensional embedding. For example, for each item, the item features may include item description data 613 of the item, which may include item title, description, item type of the item. An item description embedding 623 and a description vectorized average embedding 624 may be computed based on the item description data 613. The candidate model 632 can be configured to generate a combined item embedding for the item. The neural network for the candidate model 632 includes multiple layers and hyperparameters and weights to be optimized for generating each of the embeddings 623, 624 and the combined item embedding by the candidate model 632.

The combined model 640 in this example is trained to compute an affinity score for each pair of seller embedding and item embedding computed by the seller model 631 and the item model 632, respectively. In some examples, the combined model 640 may compute an affinity score for each item-seller pair based on a dot product of the seller embedding and the item embedding for the item and the seller, respectively in the pair. Based on the affinity scores of all item-seller pairs, the combined model 640 may determine and store, for each query, top K neighboring candidates each with a corresponding approximate nearest neighbor (ANN) index 645. In some examples, for each seller, top K1 items having highest affinity scores with respect to the seller are identified and stored in association with the seller. In some examples, for each item, top K2 sellers having highest affinity scores with respect to the item are identified and stored in association with the item. Each of the K, K1, K2 may be a predetermined positive integer.

As shown in FIG. 6, the retrieval model 601 is a multi-tower retrieval model including the query or seller model 631, the candidate or item model 632 and the combined model 640. All the hyperparameters and weights in the retrieval model 601 can be trained together to find their optimal values, to optimize an objective function based on a same set of training data. The training data may include: the seller ID 611, the other seller features 612 and the item description data 613. The training data may also include labelled affinity scores for item-seller combinations. In some examples, for each seller in the training data, an item within a catalog of the seller, i.e. being sold by the seller, is labelled to have an affinity score of 1 with respect to the seller; while an item outside the catalog of the seller, i.e. not being sold by the seller, is labelled to have an affinity score of 0 with respect to the seller. In some examples, the objective function may represent a combined difference between a computed affinity score and a labelled affinity score for each of the item-seller combinations. In this case, the training of the retrieval model 601 can find the optimal hyperparameters and weights in the retrieval model 601 to minimize the objective function.

In some examples, after training the retrieval model 601 including the query model 631, the candidate model 632 and the combined model 640, the ANN indexing 645 is generated. For example, for each respective seller, a list of item indices may be generated based on affinity scores computed based on the retrieval model 601 to indicate closest item neighbors to the respective seller. For example, for each respective item, a list of seller indices may be generated based on affinity scores computed based on the retrieval model 601 to indicate closest seller neighbors to the respective item. For example, for each respective seller, a list of seller indices may be generated based on affinity scores computed based on the retrieval model 601 to indicate closest seller neighbors to the respective seller. For example, for each respective item, a list of item indices may be generated based on affinity scores computed based on the retrieval model 601 to indicate closest item neighbors to the respective item.

In some embodiments, each of the query model 631, the candidate model 632 and the combined model 640 may be agnostic to geography and language. In various embodiments, each of the seller ID 611, the other seller features 612, the item description data 613 and the interaction data 615 may be stored in the database 116, or in a standalone database.

In some embodiments, the filtering model 602 may be trained together with the retrieval model 601. In some embodiments, the filtering model 602 may be trained separately from the retrieval model 601. As shown in FIG. 6, the filtering model 602 includes one or more filters 650 built based on the interaction data 615 of sellers. The filters 650 can be used to filter out invalid candidates 660 generated by the retrieval model 601.

In some examples, the retrieval model 601 may generate a list of recommended item-seller combinations based on a request. For example, given a query seller, the retrieval model 601 may generate a list of items each of which has a higher-than-threshold affinity score when being paired with the query seller. The filtering model 602 can be used to filter the list of recommended item-seller combinations to remove: e.g. items already in a catalog of the query seller, and items already recommended to the query seller before.

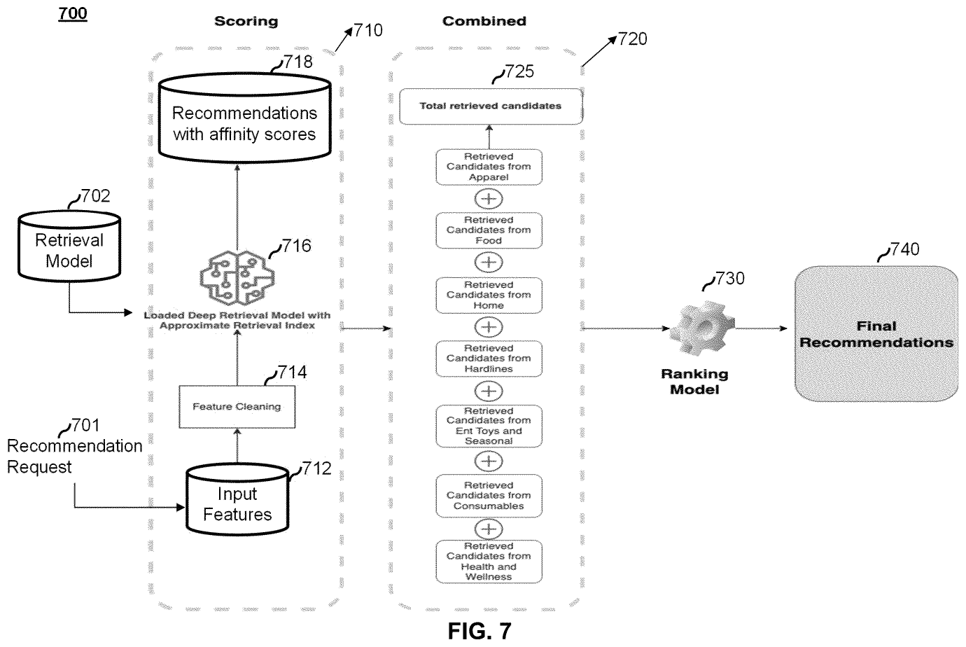

FIG. 7 illustrates an exemplary process 700 for generating recommendations based on a retrieval model 702, in accordance with some embodiments of the present teaching. In some embodiments, the process 700 can be carried out by one or more computing devices, such as the recommendation computing device 102 and/or the cloud-based engine 121 of FIG. 1. The retrieval model 702 may be stored in the database 116 or in a standalone database. The retrieval model 702 may be pre-trained and have structure as shown in FIG. 6.

As shown in FIG. 7, the process 700 comprises a scoring operation 710 and a combination operation 720. During an inference stage, the system may receive a recommendation request 701 and determine input features 712 based on the recommendation request 701. In some examples, the recommendation request 701 is requesting item recommendation for an existing seller; and the input features 712 include features about the existing seller. In some examples, the recommendation request 701 is requesting item recommendation for a new or cold start seller; and the input features 712 include features about the new seller or features about an existing item being sold by the new seller. In other examples, the recommendation request 701 is requesting seller recommendation for a new or cold start item; and the input features 712 include features about the item. At operation 714, the input features 712 are cleaned up, e.g. to remove redundant or irrelevant features. At operation 716, the retrieval model 702 is loaded and applied to the cleaned features to determine recommendations 718 with affinity scores. In some embodiments, the recommendations 718 are generated for each division of a plurality of divisions in the marketplace. The recommendations 718 with affinity scores of all divisions are sent to the operation 720 for combination.

At operation 720, all recommendations of all divisions (7 divisions in this example) are combined to generate total retrieved candidates 725. A ranking model 730 may be used to rank the total retrieved candidates 725 to generate a ranked list of recommendations. The ranking model 730 may be pre-trained based on seller and item embeddings. The final recommendations 740 may be generated based on the ranked list, e.g. including merely top M recommendations from the ranked list, where M is a predetermined positive integer.

The ranking model 730 can further reduce and refine recommendations. In some embodiments, the ranking model 730 takes seller and item features (title, description, etc.) to give a ranking for each seller-item combination. In some embodiments, to create the ranking, the ranking model 730 takes aggregate orders at item levels and merges them in the item-seller combination file. Then, the ranking model 730 can use percentiles to create multiple ranking buckets, e.g. 10 ranking buckets from 1 to 10 (90 percentile and above as Rank 10, 80-90 percentile as Rank 9,so on and so forth). The ranking would be used as a target variable for ranking model. If an item has a very high volume of orders, all the sellers for this item should get higher orders and thus its ranking should be higher, irrespective who is selling that item. This may take care of popularity bias for items as well. In some embodiments, the seller embedding as well as item title vectorizer embedding may be used to train a multi-layer neural network model, as the ranking model 730, to compute continuous rankings.

In some examples, the recommendation request 701 is seeking item recommendation for an existing seller. The input features 712 include features of the existing seller. At operation 716, a pre-trained seller model in the retrieval model 702 is applied to the features of the existing seller to compute a query seller embedding; and a list of candidate item embeddings is determined based on a pre-trained item model (and a combined model) in the retrieval model 702. In some embodiments, the list of candidate item embeddings is determined for each division of a plurality of divisions in the marketplace; and the list of candidate item embeddings have highest affinity scores to the query seller embedding, where the affinity scores are computed based on the retrieval model 702. In this case, the recommendations 718 include a list of recommended items for the existing seller, where each of the recommended items is associated with an affinity score with respect to the existing seller. All candidate item embeddings from all divisions are combined at the operation 720 to generate a combined list of candidate item embeddings. The combined list of candidate item embeddings are ranked to generate a ranked list based on the pre-trained ranking model 730. The final recommendations 740 in this case includes a list of recommended items ranked on top of the ranked list.

In some examples, the recommendation request 701 is seeking seller recommendation for a cold-start item. The input features 712 include features of the cold-start item. At operation 716, a pre-trained item model in the retrieval model 702 is applied to the features of the cold-start item to compute a cold-start item embedding; and a list of candidate seller embeddings is determined based on a pre-trained seller model (and a combined model) in the retrieval model 702. In some embodiments, the list of candidate seller embeddings is determined for each division of a plurality of divisions in the marketplace; and the list of candidate seller embeddings have highest affinity scores to the cold-start item embedding, where the affinity scores are computed based on the retrieval model 702. In this case, the recommendations 718 include a list of recommended sellers for the cold-start item, where each of the recommended sellers is associated with an affinity score with respect to the cold-start item. All candidate seller embeddings from all divisions are combined at the operation 720 to generate a combined list of candidate seller embeddings. The combined list of candidate seller embeddings are ranked to generate a ranked list based on the pre-trained ranking model 730. The final recommendations 740 in this case includes a list of recommended sellers ranked on top of the ranked list.

In some examples, the recommendation request 701 is seeking item recommendation for a cold-start seller selling an existing item. The input features 712 include features of the existing item. At operation 716, a pre-trained item model in the retrieval model 702 is applied to the features of the existing item to compute a query item embedding; and a list of candidate item embeddings is determined based on the pre-trained item model (and a combined model) in the retrieval model 702. In some embodiments, the list of candidate item embeddings is determined for each division of a plurality of divisions in the marketplace; and the list of candidate item embeddings have highest affinity scores to the query item embedding, where the affinity scores are computed based on the retrieval model 702. In this case, the recommendations 718 include a list of recommended items for the cold-start seller, where each of the recommended items is associated with an affinity score. All candidate item embeddings from all divisions are combined at the operation 720 to generate a combined list of candidate item embeddings. The combined list of candidate item embeddings are ranked to generate a ranked list based on the pre-trained ranking model 730. The final recommendations 740 in this case includes a list of recommended items ranked on top of the ranked list.

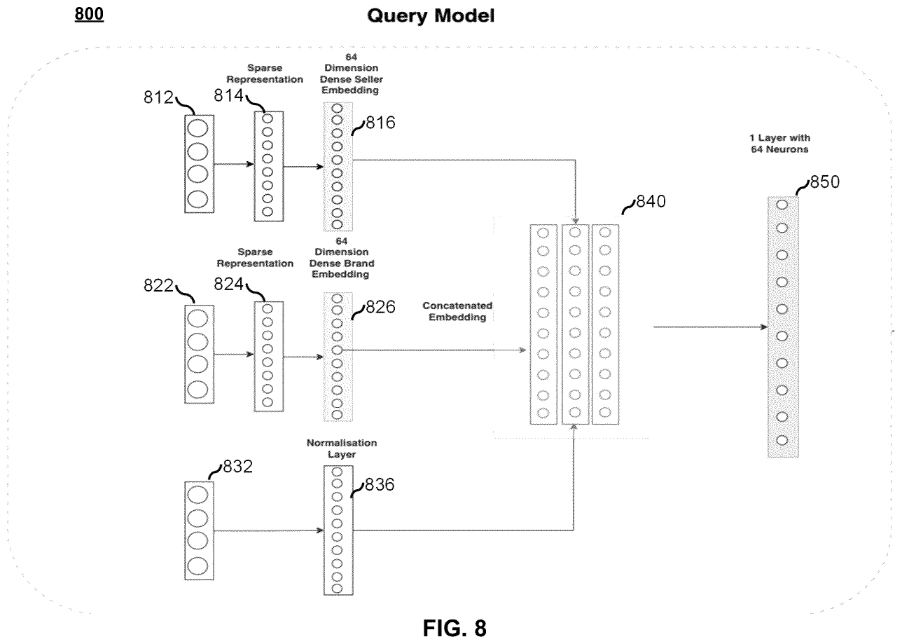

FIG. 8 illustrates an exemplary structure of a query model 800, in accordance with some embodiments of the present teaching. In some embodiments, the query model 800 may be implemented as any of the query models or seller models shown or described referring to FIGS. 1-7.

As shown in FIG. 8, the query model 800 in this example is built based on a neural network, which receives inputs of various seller features, including: seller ID feature 812 representing a seller ID of a seller, brand feature 822 representing a brand carried by the seller, and existing time feature 832 representing how long the seller has been selling items in the marketplace. The query model 800 generates a sparse vector representation 814 for the seller ID feature 812, and converts the sparse vector representation 814 into a high dimensional seller vector embedding 816, which in this example is a 64-dimensional dense seller embedding. Similarly, the query model 800 generates a sparse vector representation 824 for the brand feature 822, and converts the sparse vector representation 824 into a high dimensional brand vector embedding 826, which in this example is a 64-dimensional dense brand embedding. In addition, the query model 800 generates a normalization layer embedding 836 for the existing time feature 832.

As shown in FIG. 8, the query model 800 in this example combines the high dimensional seller vector embedding 816, the high dimensional brand vector embedding 826 and the normalization layer embedding 836 to generate a concatenated embedding 840. The output of the query model 800 may be a query seller embedding 850 converted from the concatenated embedding 840 in a neural network layer with multiple neurons, e.g. 64 neurons in this example.

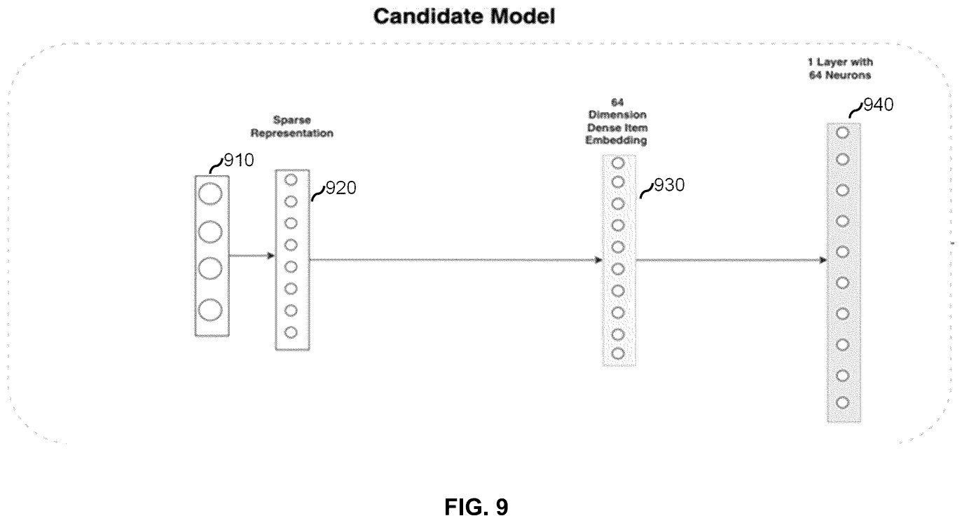

FIG. 9 illustrates an exemplary structure of a candidate model 900, in accordance with some embodiments of the present teaching. In some embodiments, the candidate model 900 may be implemented as any of the candidate models or item models shown or described referring to FIGS. 1-7.

As shown in FIG. 9, the candidate model 900 in this example is built based on a neural network, which receives inputs of item features 910, which may include item titles and/or item descriptions. The candidate model 900 generates a sparse vector representation 920 for the item features 910, and converts the sparse vector representation 920 into a high dimensional item vector embedding 930, which in this example is a 64-dimensional dense item embedding. The output of the candidate model 900 may be a candidate item embedding 940 converted from the high dimensional item vector embedding 930 in a neural network layer with multiple neurons, e.g. 64 neurons in this example. If there are multiple types of item features input to the candidate model 900, a concatenated embedding may be generated for an item, similar to the concatenated embedding 840 in FIG. 8, and the output of the candidate model 900 would be generated based on the concatenated embedding for the item.

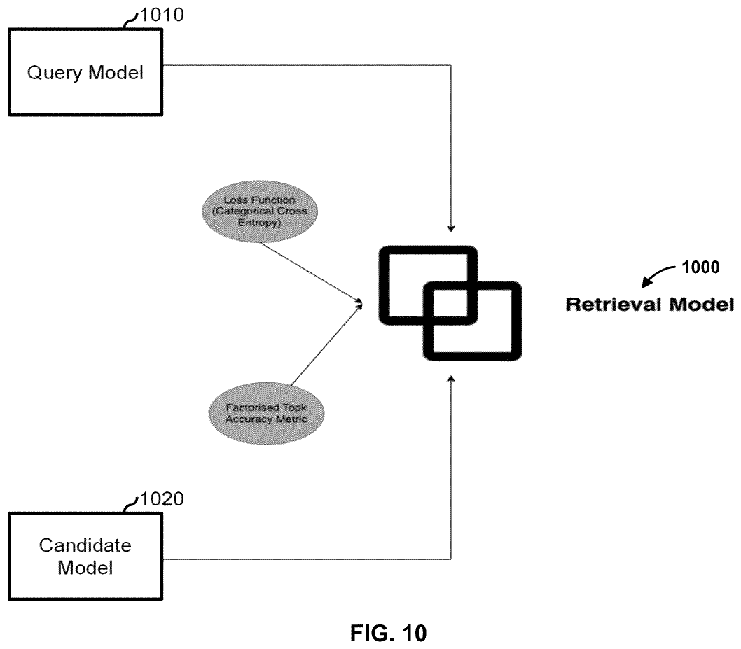

FIG. 10 illustrates an exemplary structure of a deep retrieval model 1000, in accordance with some embodiments of the present teaching. In some embodiments, the deep retrieval model 1000 may be implemented as any of the retrieval models shown or described referring to FIGS. 1-7.

As shown in FIG. 10, the deep retrieval model 1000 in this example is built based on a query model 1010 and a candidate model 1020. The query model 1010 may have the same structure as that of the query model 800 in FIG. 8. The candidate model 1020 may have the same structure as that of the candidate model 900 in FIG. 9. The outputs of the query model 1010 and the candidate model 1020 may be combined, e.g. by a combined model, to obtain the deep retrieval model 1000. In some embodiments, a categorical cross entropy may be used as a loss function along with factorized top K accuracy metric to train the deep retrieval model 1000, to compute the affinity score for each query-candidate pair or item-seller pair.

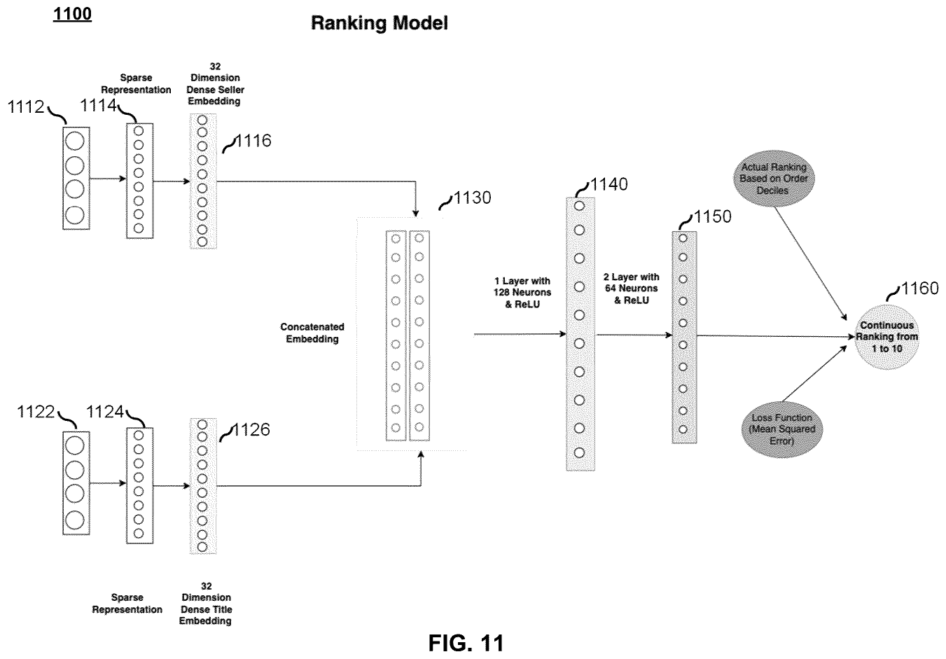

FIG. 11 illustrates an exemplary process for training a ranking model 1100, in accordance with some embodiments of the present teaching. In some embodiments, the ranking model 1100 may be implemented as any of the ranking models shown or described referring to FIGS. 1-7. The ranking model 1100 may further reduce and refine recommendations.

As shown in FIG. 11, the ranking model 1100 in this example is built based on a multi-layer neural network, which receives inputs of seller features 1112 and item features 1122. While the seller features 1112 may include seller ID, brand feature and/or existing time feature; the item features 1122 may include item titles and/or item descriptions. The ranking model 1100 generates a sparse vector representation 1114 for the seller features 1112, and converts the sparse vector representation 1114 into a high dimensional seller vector embedding 1116, which in this example is a 32-dimensional dense seller embedding. Similarly, the ranking model 1100 also generates a sparse vector representation 1124 for the item features 1122, and converts the sparse vector representation 1124 into a high dimensional item vector embedding 1126, which in this example is a 32-dimensional dense item embedding.

As shown in FIG. 11, the ranking model 1100 in this example combines the high dimensional seller vector embedding 1116 and the item vector embedding 1126 to generate a concatenated embedding 1130. In this example, the concatenated embedding 1130 goes through a first neural network layer 1140 with 128 neurons and rectified linear unit (ReLU), and a second neural network layer 1150 with 64 neurons and rectified linear unit (ReLU). The output of the ranking model 1100 may be a continuous ranking 1160, e.g. from 1 to 10. For example, for each item-seller combination, the ranking model 1100 takes the seller features and item features of the combination as inputs, to give a ranking for this item-seller combination.

In some embodiments, a loss function based on mean squared error (MSE) may be used to train the ranking model 1100, to determine the continuous ranking. The target variable representing a labelled or actual ranking may be created based on order deciles. For example, the top 10 percentiles (top decile) are taken as Rank 10, the next 10 percentiles are taken as Rank 9, so on and so forth, for the number of orders placed for a particular item in a past period, e.g. last 2 years.

The ranking given by the ranking model 1100 is for each item-seller combination. As discussed above, for different request types, the recommended item-seller combinations may share a same seller, or a same item. In some examples, a first list of recommended item-seller combinations share a same seller, e.g. a same existing or new seller. Then, once the rankings for the first list of recommended item-seller combinations are determined by the ranking model 1100, the same rankings can be applied to all items in the first list with respect to the same shared existing or new seller. In some examples, a second list of recommended item-seller combinations share a same item, e.g. a cold-start or new item. Then, once the rankings for the second list of recommended item-seller combinations are determined by the ranking model 1100, the same rankings can be applied to all sellers in the second list with respect to the same shared item.

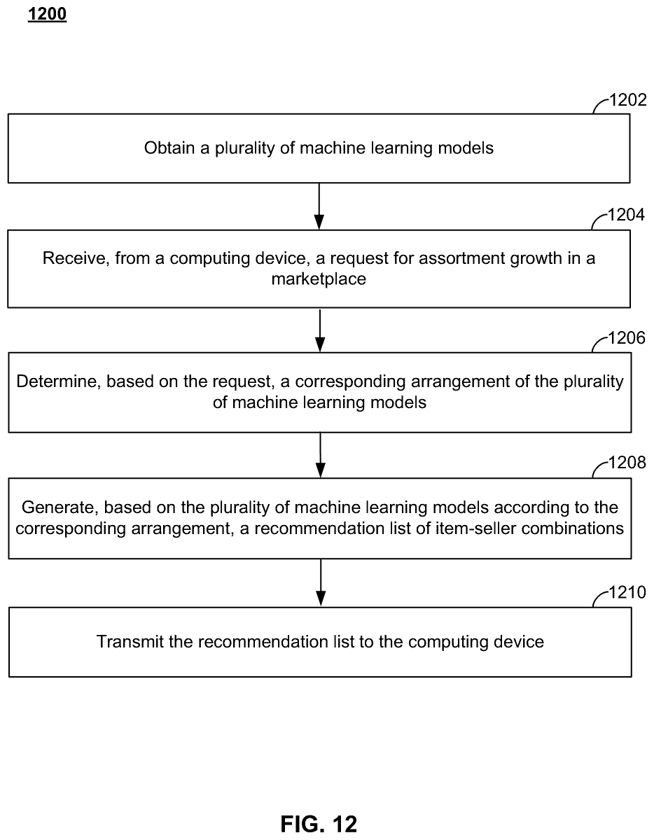

FIG. 12 is a flowchart illustrating an exemplary method 1200 for recommending item-seller combinations, in accordance with some embodiments of the present teaching. In some embodiments, the method 1200 can be carried out by one or more computing devices, such as the recommendation computing device 102 and/or the cloud-based engine 121 of FIG. 1. Beginning at operation 1202, a plurality of machine learning models are obtained. At operation 1204, a request for assortment growth in a marketplace is received from a computing device. Based on the request, a corresponding arrangement of the plurality of machine learning models is determined at operation 1206. Based on the plurality of machine learning models according to the corresponding arrangement, a recommendation list of item-seller combinations is generated at operation 1208. The recommendation list is transmitted at operation 1210 to the computing device.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMS, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain a plurality of machine learning models,
receive, from a computing device, a request for assortment growth in a marketplace,
determine, based on the request, a corresponding arrangement of the plurality of machine learning models,
generate, based on the plurality of machine learning models according to the corresponding arrangement, a recommendation list of item-seller combinations, and
transmit the recommendation list to the computing device.

2. The system of claim 1, wherein:
the plurality of machine learning models comprises a seller model and an item model;
the seller model is configured to compute a seller embedding for a seller based on features of the seller; and
the item model is configured to compute an item embedding for an item based on features of the item.

3. The system of claim 2, wherein:
the request is seeking item recommendation for an existing seller;
the corresponding arrangement includes the seller model followed by the item model; and
the recommendation list includes a list of recommended items for the existing seller.

4. The system of claim 3, wherein the recommendation list is generated based on:
obtaining features of the existing seller;
applying the seller model to the features of the existing seller to compute a query seller embedding; and
determining, for each division of a plurality of divisions in the marketplace, a list of candidate item embeddings having highest affinity scores to the query seller embedding based on the item model, wherein the affinity scores are computed based on a pre-trained retrieval model.

5. The system of claim 4, wherein the recommendation list is generated further based on:
combining all candidate item embeddings from all divisions to generate a combined list of candidate item embeddings;
ranking the combined list of candidate item embeddings to generate a ranked list based on a pre-trained ranking model; and
generating the list of recommended items based on the ranked list.

6. The system of claim 2, wherein:
the request is seeking seller recommendation for a cold-start item;
the corresponding arrangement includes the item model followed by the seller model; and
the recommendation list includes a list of recommended sellers for the cold-start item.

7. The system of claim 6, wherein the recommendation list is generated based on:
obtaining features of the cold-start item;
applying the item model to the features of the cold-start item to compute a cold-start item embedding;
determining, for each division of a plurality of divisions in the marketplace, a list of candidate seller embeddings having highest affinity scores to the cold-start item embedding based on the seller model, wherein the affinity scores are computed based on a pre-trained retrieval model;
combining all candidate seller embeddings from all divisions to generate a combined list of candidate seller embeddings;
ranking the combined list of candidate seller embeddings to generate a ranked list based on a pre-trained ranking model; and
generating the list of recommended sellers based on the ranked list.

8. The system of claim 2, wherein:
the request is seeking item recommendation for a cold-start seller selling an existing item;
the corresponding arrangement includes the item model followed by the item model; and
the recommendation list includes a list of recommended items for the cold-start seller.

9. The system of claim 8, wherein the recommendation list is generated based on:
obtaining features of the existing item;
applying the item model to the features of the existing item to compute a query item embedding;
determining, for each division of a plurality of divisions in the marketplace, a list of candidate item embeddings having highest affinity scores to the query item embedding based on the item model, wherein the affinity scores are computed based on a pre-trained retrieval model;
combining all candidate item embeddings from all divisions to generate a combined list of candidate item embeddings;
ranking the combined list of candidate item embeddings to generate a ranked list based on a pre-trained ranking model; and
generating the list of recommended items based on the ranked list.

10. The system of claim 2, wherein the at least one processor is further configured to read the instructions to:
train a multi-tower retrieval model including the seller model, the item model and a combined model based on neural networks using a same set of training data, wherein
the combined model is trained to compute an affinity score for each pair of seller embedding and item embedding computed by the seller model and the item model, respectively; and
the multi-tower retrieval model is trained to determine hyperparameters and weights in the seller model, the item model and the combined model for optimizing an objective function based on labelled affinity scores in the training data.

11. The system of claim 10, wherein the at least one processor is further configured to read the instructions to:
generate, for each respective seller, a list of item indices indicating closest item neighbors to the respective seller based on affinity scores computed based on the trained multi-tower retrieval model;
generate, for each respective item, a list of seller indices indicating closest seller neighbors to the respective item based on affinity scores computed based on the trained multi-tower retrieval model;
generate, for each respective seller, a list of seller indices indicating closest seller neighbors to the respective seller based on affinity scores computed based on the trained multi-tower retrieval model; and
generate, for each respective item, a list of item indices indicating closest item neighbors to the respective item based on affinity scores computed based on the trained multi-tower retrieval model.

12. The system of claim 10, wherein:
the seller model, the item model and the combined model are agnostic to geography and language.

13. The system of claim 1, wherein the recommendation list is generated based on:
filtering, based on at least one filtering model, a list of recommended item-seller combinations to remove: items already in a catalog of a query seller, and items already recommended to a query seller.

14. A computer-implemented method, comprising:
obtaining a plurality of machine learning models;
receiving, from a computing device, a request for assortment growth in a marketplace;
determining, based on the request, a corresponding arrangement of the plurality of machine learning models;
generating, based on the plurality of machine learning models according to the corresponding arrangement, a recommendation list of item-seller combinations; and
transmitting the recommendation list to the computing device.

15. The computer-implemented method of claim 14, wherein:
the plurality of machine learning models comprises a seller model and an item model;
the seller model is configured to compute a seller embedding for a seller based on features of the seller; and
the item model is configured to compute an item embedding for an item based on features of the item.

16. The computer-implemented method of claim 15, wherein:
the request is seeking item recommendation for an existing seller;
the corresponding arrangement includes the seller model followed by the item model; and
the recommendation list includes a list of recommended items for the existing seller.

17. The computer-implemented method of claim 15, wherein:
the request is seeking seller recommendation for a cold-start item;
the corresponding arrangement includes the item model followed by the seller model; and
the recommendation list includes a list of recommended sellers for the cold-start item.

18. The computer-implemented method of claim 15, wherein:
the request is seeking item recommendation for a cold-start seller selling an existing item;
the corresponding arrangement includes the item model followed by the item model; and
the recommendation list includes a list of recommended items for the cold-start seller.

19. The computer-implemented method of claim 15, further comprising:
training a multi-tower retrieval model including the seller model, the item model and a combined model based on neural networks using a same set of training data, wherein
the combined model is trained to compute an affinity score for each pair of seller embedding and item embedding computed by the seller model and the item model, respectively; and
the multi-tower retrieval model is trained to determine hyperparameters and weights in the seller model, the item model and the combined model for optimizing an objective function based on labelled affinity scores in the training data.

20. A non-transitory computer readable medium having instructions stored thereon, wherein the instructions, when executed by at least one processor, cause at least one device to perform operations comprising:
obtaining a plurality of machine learning models;
receiving, from a computing device, a request for assortment growth in a marketplace;
determining, based on the request, a corresponding arrangement of the plurality of machine learning models;
generating, based on the plurality of machine learning models according to the corresponding arrangement, a recommendation list of item-seller combinations; and
transmitting the recommendation list to the computing device.
